(19) United States
(12) Patent Application Publication
(10) Pub. No.: US 2024/0289598 A1
(43) Pub. Date: Aug. 29, 2024

(54) APPARATUS AND METHOD FOR REINFORCEMENT LEARNING BASED POST-TRAINING SPARSIFICATION

(71) Applicant: Intel Corporation, Santa Clara, CA (US)

(72) Inventors: Xu QIAN, Shanghai (CN); Darren CREWS, Portland, OR (US); Yuanyuan LI, Shanghai (CN)

(21) Appl. No.: 18/566,481

(22) PCT Filed: Nov. 15, 2021
(86) PCT No.: PCT/CN2021/130746

§ 371 Date: Dec. 1, 2023

(51) Int. Cl. G06N 3/0495

(52) U.S. Cl. CPC G06N 3/0495

(57) ABSTRACT

Provided herein are apparatus and methods for reinforcement learning based post-training sparsification. An apparatus includes: a memory; and processor circuitry coupled with the memory, wherein the processor circuitry is to: obtain a first correction parameter indicating a mean shift of a set of weights after sparsification of a model with respect to that before the sparsification of the model; obtain a second correction parameter indicating a variance shift of the set of weights after the sparsification of the model with respect to that before the sparsification of the model; and correct the set of weights at least partially based on the first correction parameter and the second correction parameter, and wherein the memory is to store the corrected set of weights. Other embodiments may also be disclosed and claimed.

### TECHNICAL FIELD

Embodiments of the present disclosure generally relate to reinforcement learning (RL), and in particular to apparatus and methods for reinforcement learning based post-training sparsification.

### BACKGROUND ART

In recent years, machine learning and/or artificial intelligence have increased in popularity. For example, machine learning and/or artificial intelligence may be implemented using neural networks. Neural networks are computing systems inspired by the neural networks of human brains. A neural network can receive an input and generate an output. The neural network can be trained (e.g., can learn) based on feedback so that the output corresponds to a desired result. Once trained, the neural network can make decisions to generate an output based on any input.

### SUMMARY

An aspect of the disclosure provides an apparatus, comprising: a memory; and processor circuitry coupled with the memory, wherein the processor circuitry is to: obtain a first correction parameter indicating a mean shift of a set of weights after sparsification of a model with respect to that before the sparsification of the model; obtain a second correction parameter indicating a variance shift of the set of weights after the sparsification of the model with respect to that before the sparsification of the model; and correct the set of weights at least partially based on the first correction parameter and the second correction parameter, and wherein the memory is to store the corrected set of weights.

An aspect of the disclosure provides a method, comprising: obtaining a first correction parameter indicating a mean shift of a set of weights after sparsification of a model with respect to that before the sparsification of the model; obtaining a second correction parameter indicating a variance shift of the set of weights after the sparsification of the model with respect to that before the sparsification of the model; and correcting the set of weights at least partially based on the first correction parameter and the second correction parameter.

An aspect of the disclosure provides a computer-readable medium having instructions stored thereon, the instructions when executed by processor circuitry cause the processor circuitry to: obtain a first correction parameter indicating a mean shift of a set of weights after sparsification of a model with respect to that before the sparsification of the model; obtain a second correction parameter indicating a variance shift of the set of weights after the sparsification of the model with respect to that before the sparsification of the model; and correct the set of weights at least partially based on the first correction parameter and the second correction parameter.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 illustrates an example of a post-training model compression engine in accordance with some embodiments of the disclosure.

FIG. 2 illustrates a flowchart of a method for reinforcement learning based post-training sparsification in accordance with some embodiments of the disclosure.

FIG. 3 is a block diagram illustrating components, according to some example embodiments, able to read instructions from a machine-readable or computer-readable medium and perform any one or more of the methodologies discussed herein.

FIG. 4 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

A deep learning program typically have two phases, training and inference. Training requires a large set of data and is very computationally intensive. However, the training process does not need to respond with the constraint of ‘real time’. On the other hand, inference requires fewer computation resources relatively, but it is still a difficult problem to achieve real time inference on most of Deep Neural Network (DNN) applications, especially on platforms without large scale parallel computing units.

Post-training optimization is needed for speeding up inference and fast deployment. For neural networks, weights are usually normally distributed. As a result, a lot of weights are very close to zero. Through model sparsification, some small weights are directly mapped to zero so the multiplications with zero as an operand can be skipped.

Some products (e.g., Intel® Movidius™) (e.g., a Vision Processing Unit (VPU) Keem Bay) may support unstructured weight sparsification. However, the accuracy of the model would drop dramatically after sparsification if the structure of the model (channels, blocks) is not taken into consideration when performing sparsification, especially without retraining of the model.

In the disclosure, a sparsity aware bias correction method is proposed to compensate the sparsed model in order to increase accuracy of the model. Moreover, reinforcement learning (RL) based Deep Deterministic Policy Gradient (DDPG) agent is used to search for the optimal sparsity ratios of different layers in an iterative manner so as to increase accuracy of sparsity searching.

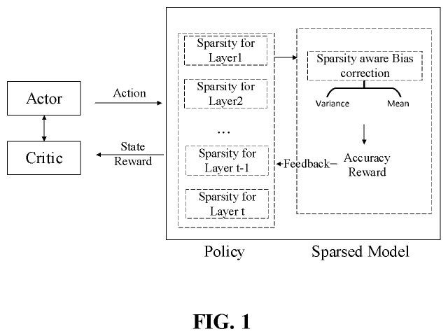

FIG. 1 illustrates an example of a post-training model compression engine in accordance with some embodiments of the disclosure. It is aimed to automatically find the redundancy for each layer, characterized by sparsity. A RL agent is trained to predict an action(s) and give the sparsity, then perform the sparsification. After the sparsification, a sparsity aware bias correction method is used to compensate for mean shift and variance shift of the sparsed model. The accuracy is quickly evaluated after the bias correction but before fine-tuning as an effective delegate of final accuracy. Then the agent is updated by encouraging smaller, faster and more accurate models.

Below, the sparsity aware bias correction solution and the RL based DDPG agent will be described.

It is observed that there is an inherent bias in the mean and the variance of the weight values after their sparsification. Formally, the weights before sparsification may be denoted by W and its sparsed version may be denoted by Wₛ. It is observed that both of expectation and norm of W and Wₛ are different, for example, E(W)≠E(Wₛ) and ∥W−E(W)∥₂≠∥Wₛ−E(Wₛ)∥₂. The expectation operation is to indicate the mean of the weights. The norm operation is to indicate the variance of the weights.

In some embodiments, the quantization bias may be compensated. For a more fine-grained compensation, the compensation may be performed in a per-channel manner, for example, each channel of a layer of the model may be compensated respectively. The weights of channel c may be denoted by W^{c}∈W and its sparsed version may be denoted by Wₛ^{c}. Two correction parameters μ^{c} and ε^{c} for channel c may be obtained as equations (1) and (2).

$${μ}^{c} = E ( {W}^{c} ) - E ( {W}_{s}^{c} ) \qquad ( 1 )$$

$${ε}^{c} = \frac{{‖ {W}^{c} - E ( {W}^{c} ) ‖}_{2}}{{‖ {W}_{s}^{c} - E ( {W}_{s}^{c} ) ‖}_{2}} \qquad ( 2 )$$

In some embodiments, all the weights may be compensated directly. However, this would severely hurt the model sparsity because all zeros are compensated with μ^{c}.

In some embodiments, in order to keep the sparsity after bias correction, the sparsity (denoted by s, and (1−s) indicating the density of the weights) for the weights of a corresponding channel c may be taken into account in the compensation as equation (3) below.

$$w = {ε}^{c} \times ( w + {μ}^{c} / ( 1 - s ) ) ∀ w ∈ {W}_{s}^{c} and w \neq 0 \qquad ( 3 )$$

As seen from equation (3), only the non-zero weights are compensated. In this way, the sparsity is kept, so that the mean stays the same.

Below, iterative search of sparsity with RL agent will be described.

In some embodiments, RL is leveraged for efficient search over action space. In some embodiments, DDPG agent is used to generate a continuous action space a∈(0, 1].

In some embodiments, a State Space is defined. Specifically, for each layer t, 10 features that characterize the state sₜ may be considered. For example, features (t, n, c, h, w, stride, k, reduced, rest, aₜ₋₁) are considered. Among them, t is a layer index, n is a batch size, c is an input channel size, h is a height of a feature map, w is a width of a feature map, stride is a kernel's stride, k is a kernel size, reduced is a total number of reduced model size in previous layers, rest is a number of remaining model size in following layers, and aₜ₋₁ is the last action from previous layer. The dimension of the kernel is n×c×k×k, and the input is c×h×w. Before being passed to the agent, they are scaled within [0, 1]. Such features are essential for the agent to distinguish one convolutional layer from another.

In some solutions (for example in Openvino), the post-training sparsity of all the layers in a network is constrained to the same ratio. Different layers of neural networks have different redundancy. Uniformly setting all the layers to the same sparsity level would decrease the accuracy.

In some embodiments of the disclosure, sparsity ratios are set respectively for the layers.

In some embodiments, DDPG agent is proposed. As illustrated in FIG. 1, the agent first searches the sparsity ratio of each of the layers. Then the agent uses the actions from the Actor to sparse the model. After sparsification, the sparsity aware bias correction method of the disclosure is used to compensate for the inherent shift and variance of the weights. The reward accuracy is evaluated on a validation set and returned to the agent. State and reward are returned to Critic.

In some embodiments, for fast exploration, the reward accuracy may be evaluated on a portion (e.g., 1/10) of the original test set without fine-tuning, which is a good approximation for fine-tuned accuracy. In this way, exploration speed can be increased so as to speed up the inference.

In some embodiments, the reinforcement learning algorithm in this disclosure may include three parts: 1) an agent, as in FIG. 1, the actor critic model; 2), the environment that feeds in the agent and gets the sparsity of the current layer; and 3) an evaluation function that evaluates the model corresponding to the current sparsities and feedbacks the evaluation score to the agent.

In practice, it is realized that directly searching a high overall sparsity ratio would often ends with sub-optimal results. In some embodiments, to reduce the search effort of the agent, the sparsity search may be performed in an iterative manner. For example, for a 40% overall sparsity level, search may be performed for 20% overall sparsity, then the 20% sparsed model may be used to search for 30% overall sparsity, and finally, the 30% sparsed model may be used to search for 40% overall sparsity.

To demonstrate the effectiveness of the solutions proposed in the disclosure, various algorithms are tested on Mobilenetv2. Table 1 illustrates accuracy comparison for the various algorithms.

As shown in Table 1, for the baseline, 71.84% top-1 accuracy is obtained. For the Openvino solution, the top-1 accuracy at 30% sparsity is 69.10%. With the help of RL without both of iterative search and bias correction, the accuracy top-1 is about 69.75%. After adding iterative search, the accuracy increases to 70.23%. After further adding sparsity aware bias correction, the accuracy finally reaches 70.99%.

TABLE 1
Accuracy comparison

| Mobilenetv2 | Sparsity | Accuracy Top-1 |
|---|---|---|
| baseline | NA | 71.84% |
| Openvino | 30% | 69.10% |
| RL without iterative search | 30% | 69.75% |
| and bias correction | | |
| RL with iterative search | 30% | 70.23% |
| without bias correction | | |
| RL with iterative search and | 30% | 70.99% |
| bias correction | | |

Therefore, 70.99% top-1 accuracy at 30% sparsity for Mobilenetv2 can be obtained using the RL with both of iterative search and bias correction as the disclosure, which is 1.8% higher than Openvino's current solution.

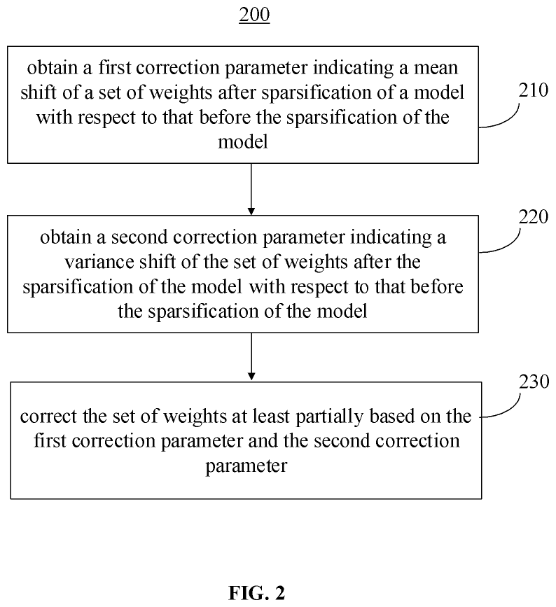

FIG. 2 illustrates a flowchart of a method 200 for reinforcement learning based post-training sparsification in accordance with some embodiments of the disclosure. The method 200 may include steps 210 to 230.

At 210, a first correction parameter is obtained. The first correction parameter is to indicate a mean shift of a set of weights after sparsification of a model with respect to that before the sparsification of the model.

At 220, a second correction parameter is obtained. The second correction parameter is to indicate a variance shift of the set of weights after the sparsification of the model with respect to that before the sparsification of the model.

At 230, the set of weights is corrected at least partially based on the first correction parameter and the second correction parameter.

In some embodiments, the method 200 may include more or less or different steps, which is not limited in the disclosure.

In some embodiments, only a non-zero weight(s) of the set of weights is corrected.

In some embodiments, the first correction parameter is based on a difference between a first mean of the set of weights before the sparsification of the model and a second mean of the set of weights after the sparsification of the model.

In some embodiments, the second correction parameter is based on a ratio between a first variance of the set of weights before the sparsification of the model and a second variance of the set of weights after the sparsification of the model.

In some embodiments, the set of weights is corrected further based on a third correction parameter indicating a sparsity ratio of a weight of the set of weights.

In some embodiments, the sparsity ratio of the weight of the set of weights is searched in an iterative manner based on an overall sparsity level.

In some embodiments, the set of weights is associated with a channel of the model.

In some embodiments, the model is sparsed based on a continuous action space.

In the disclosure, the RL based DDPG agent is used to search for the optimal sparsity ratios of different layers in an iterative manner, so as to speed up inference. Furthermore, a sparsity aware bias correction is performed to compensate the sparsed model in order to increase accuracy.

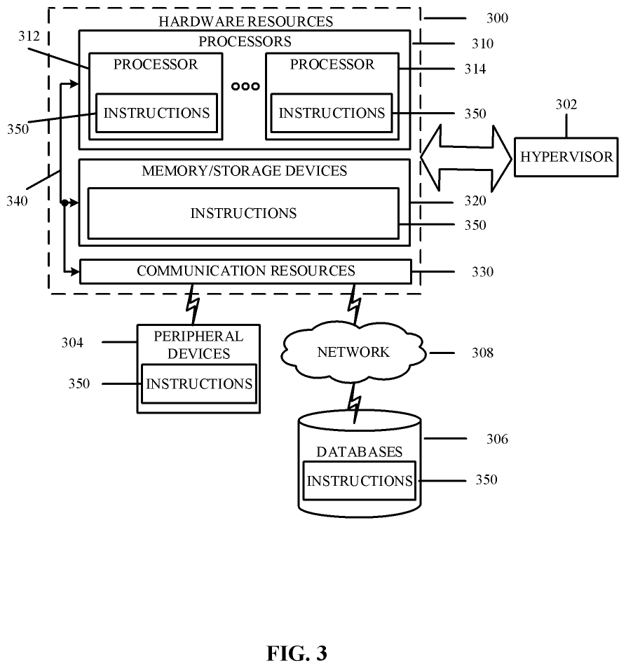

FIG. 3 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 3 shows a diagrammatic representation of hardware resources 300 including one or more processors (or processor cores) 310, one or more memory/storage devices 320, and one or more communication resources 330, each of which may be communicatively coupled via a bus 340. For embodiments where node virtualization (e.g., NFV) is utilized, a hypervisor 302 may be executed to provide an execution environment for one or more network slices/sub-slices to utilize the hardware resources 300.

The processors 310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 312 and a processor 314.

The memory/storage devices 320 may include main memory, disk storage, or any suitable combination thereof. The memory/storage devices 320 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 330 may include interconnection or network interface components or other suitable devices to communicate with one or more peripheral devices 304 or one or more databases 306 via a network 308. For example, the communication resources 330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 350 may comprise software, a program, an application, an applet, an app, or other executable code for causing at least any of the processors 310 to perform any one or more of the methodologies discussed herein. The instructions 350 may reside, completely or partially, within at least one of the processors 310 (e.g., within the processor's cache memory), the memory/storage devices 320, or any suitable combination thereof. Furthermore, any portion of the instructions 350 may be transferred to the hardware resources 300 from any combination of the peripheral devices 304 or the databases 306. Accordingly, the memory of processors 310, the memory/storage devices 320, the peripheral devices 304, and the databases 706 are examples of computer-readable and machine-readable media.

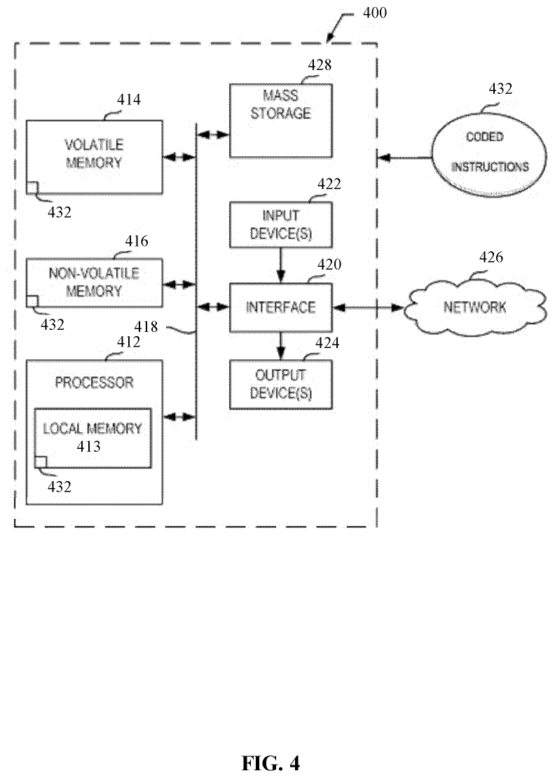

FIG. 4 is a block diagram of an example processor platform in accordance with some embodiments of the disclosure. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 400 of the illustrated example includes a processor 412. The processor 412 of the illustrated example is hardware. For example, the processor 412 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements the DDPG agent described above.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), a Bluetooth® interface, a near field communication (NFC) interface, and/or a PCI express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 400 of the illustrated example also includes one or more mass storage devices 428 for storing software and/or data. Examples of such mass storage devices 428 include floppy disk drives, hard drive disks, compact disk drives, Blu-ray disk drives, redundant array of independent disks (RAID) systems, and digital versatile disk (DVD) drives.

Machine executable instructions 432 may be stored in the mass storage device 428, in the volatile memory 414, in the non-volatile memory 416, and/or on a removable non-transitory computer readable storage medium such as a CD or DVD.

The following paragraphs describe examples of various embodiments.

Example 1 includes an apparatus, comprising: a memory; and processor circuitry coupled with the memory, wherein the processor circuitry is to: obtain a first correction parameter indicating a mean shift of a set of weights after sparsification of a model with respect to that before the sparsification of the model; obtain a second correction parameter indicating a variance shift of the set of weights after the sparsification of the model with respect to that before the sparsification of the model; and correct the set of weights at least partially based on the first correction parameter and the second correction parameter, and wherein the memory is to store the corrected set of weights.

Example 2 includes the apparatus of Example 1, wherein the processor circuitry is to: merely correct at least one non-zero weight of the set of weights.

Example 3 includes the apparatus of Example 1 or 2, wherein the first correction parameter is based on a difference between a first mean of the set of weights before the sparsification of the model and a second mean of the set of weights after the sparsification of the model.

Example 4 includes the apparatus of any one of Examples 1 to 3, wherein the second correction parameter is based on a ratio between a first variance of the set of weights before the sparsification of the model and a second variance of the set of weights after the sparsification of the model.

Example 5 includes the apparatus of any one of Examples 1 to 4, wherein the processor circuitry is further to: correct the set of weights further based on a third correction parameter indicating a sparsity ratio of a weight of the set of weights.

Example 6 includes the apparatus of any one of Examples 1 to 5, wherein the processor circuitry is further to: search the sparsity ratio of the weight of the set of weights in an iterative manner based on an overall sparsity level.

Example 7 includes the apparatus of any one of Examples 1 to 6, wherein the set of weights is associated with a channel of the model.

Example 8 includes the apparatus of any one of Examples 1 to 7, wherein the processor circuitry is further to: sparse the model based on a continuous action space.

Example 9 includes the apparatus of any one of Examples 1 to 8, wherein the apparatus is a part of a Deep Deterministic Policy Gradient (DDPG) agent.

Example 10 includes a method, comprising: obtaining a first correction parameter indicating a mean shift of a set of weights after sparsification of a model with respect to that before the sparsification of the model; obtaining a second correction parameter indicating a variance shift of the set of weights after the sparsification of the model with respect to that before the sparsification of the model; and correcting the set of weights at least partially based on the first correction parameter and the second correction parameter.

Example 11 includes the method of Example 10, further comprising: merely correcting at least one non-zero weight of the set of weights.

Example 12 includes the method of Example 10 or 11, wherein the first correction parameter is based on a difference between a first mean of the set of weights before the sparsification of the model and a second mean of the set of weights after the sparsification of the model.

Example 13 includes the method of any one of Examples 10 to 12, wherein the second correction parameter is based on a ratio between a first variance of the set of weights before the sparsification of the model and a second variance of the set of weights after the sparsification of the model.

Example 14 includes the method of any one of Examples 10 to 13, further comprising: correcting the set of weights further based on a third correction parameter indicating a sparsity ratio of a weight of the set of weights.

Example 15 includes the method of any one of Examples 10 to 14, further comprising: searching the sparsity ratio of the weight of the set of weights in an iterative manner based on an overall sparsity level.

Example 16 includes the method of any one of Examples 10 to 15, wherein the set of weights is associated with a channel of the model.

Example 17 includes the method of any one of Examples 10 to 16, further comprising: sparsing the model based on a continuous action space.

Example 18 includes an apparatus, comprising: means for obtaining a first correction parameter indicating a mean shift of a set of weights after sparsification of a model with respect to that before the sparsification of the model; means for obtaining a second correction parameter indicating a variance shift of the set of weights after the sparsification of the model with respect to that before the sparsification of the model; and means for correcting the set of weights at least partially based on the first correction parameter and the second correction parameter.

Example 19 includes the apparatus of Example 18, further comprising: means for merely correcting at least one non-zero weight of the set of weights.

Example 20 includes the apparatus of Example 18 or 19, wherein the first correction parameter is based on a difference between a first mean of the set of weights before the sparsification of the model and a second mean of the set of weights after the sparsification of the model.

Example 21 includes the apparatus of any one of Examples 18 to 20, wherein the second correction parameter is based on a ratio between a first variance of the set of weights before the sparsification of the model and a second variance of the set of weights after the sparsification of the model.

Example 22 includes the apparatus of any one of Examples 18 to 21, further comprising: means for correcting the set of weights further based on a third correction parameter indicating a sparsity ratio of a weight of the set of weights.

Example 23 includes the apparatus of any one of Examples 18 to 22, further comprising: means for searching the sparsity ratio of the weight of the set of weights in an iterative manner based on an overall sparsity level.

Example 24 includes the apparatus of any one of Examples 18 to 23, wherein the set of weights is associated with a channel of the model.

Example 25 includes the apparatus of any one of Examples 18 to 24, further comprising: means for sparsing the model based on a continuous action space.

Example 26 includes a computer-readable medium having instructions stored thereon, the instructions when executed by processor circuitry cause the processor circuitry to perform the method of any of Examples 10 to 17.

Example 27 includes an apparatus as shown and described in the description.

Example 28 includes a method performed at an apparatus as shown and described in the description.

Example 29 includes a Deep Deterministic Policy Gradient (DDPG) agent as shown and described in the description.

Example 30 includes a method performed at a Deep Deterministic Policy Gradient (DDPG) agent as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1. An apparatus, comprising:
a memory;
instructions; and
processor circuitry to execute the instructions to:
obtain a first correction parameter indicating a mean shift of weights after sparsification of a model with respect to the weights before the sparsification of the model;
obtain a second correction parameter indicating a variance shift of the weights after the sparsification of the model with respect to the weights before the sparsification of the model; and
correct at least one of the weights at least partially based on the first correction parameter and the second correction parameter, and
cause the memory to store the corrected weights.

2. (canceled)

3. The apparatus of claim 1, wherein the first correction parameter is based on a difference between a first mean of the weights before the sparsification of the model and a second mean of the weights after the sparsification of the model.

4. The apparatus of claim 1, wherein the second correction parameter is based on a ratio between a first variance of the weights before the sparsification of the model and a second variance of the weights after the sparsification of the model.

5. The apparatus of claim 1, wherein the processor circuitry is to:
correct the at least one of the weights based on a third correction parameter indicating a sparsity ratio associated with the weights.

6. The apparatus of claim 5, wherein the processor circuitry is to:
search the sparsity ratio associated with the weights in an iterative manner based on an overall sparsity level.

7. The apparatus of claim 1, wherein the weights are associated with a channel of the model.

8. The apparatus of claim 1, wherein the processor circuitry is to:
sparse the model based on a continuous action space.

9. The apparatus of claim 1, wherein the apparatus is a part of a Deep Deterministic Policy Gradient (DDPG) agent.

10. A method, comprising:
obtaining a first correction parameter indicating a mean shift of weights after sparsification of a model with respect to the weights before the sparsification of the model;
obtaining a second correction parameter indicating a variance shift of the weights after the sparsification of the model with respect to the weights before the sparsification of the model; and
correcting at least one of the weights at least partially based on the first correction parameter and the second correction parameter.

11. (canceled)

12. The method of claim 10, wherein the first correction parameter is based on a difference between a first mean of the weights before the sparsification of the model and a second mean of the weights after the sparsification of the model.

13. The method of claim 10, wherein the second correction parameter is based on a ratio between a first variance of the weights before the sparsification of the model and a second variance of the weights after the sparsification of the model.

14. The method of claim 10, further comprising:
correcting at least one of the weights based on a third correction parameter indicating a sparsity ratio associated with the weights.

15. (canceled)

16. (canceled)

17. (canceled)

18. A memory comprising instructions to cause processor circuitry to:
obtain a first correction parameter indicating a mean shift of weights after sparsification of a model with respect to the weights before the sparsification of the model;
obtain a second correction parameter indicating a variance shift of the weights after the sparsification of the model with respect to the weights before the sparsification of the model; and
correct at least one of the weights at least partially based on the first correction parameter and the second correction parameter.

19. The memory of claim 18, wherein the
at least one of the weights includes at least one non-zero weight.

20. The memory of claim 18, wherein the first correction parameter is based on a difference between a first mean of the weights before the sparsification of the model and a second mean of the weights after the sparsification of the model.

21. The memory of claim 18, wherein the second correction parameter is based on a ratio between a first variance of the weights before the sparsification of the model and a second variance of the set of weights after the sparsification of the model.

22. The memory of claim 18, wherein the instructions when executed by the processor circuitry cause the processor circuitry to:
correct the at least one of the weights based on a third correction parameter indicating a sparsity ratio.

23. The memory of claim 22, wherein the instructions when executed by the processor circuitry cause the processor circuitry to:
search the sparsity ratio in an iterative manner based on an overall sparsity level.

24. The memory of claim 18, wherein the weights are associated with a channel of the model.

25. The memory of claim 18, wherein the instructions when executed by the processor circuitry cause the processor circuitry to:
sparse the model based on a continuous action space.
